(19) United States
(12) Patent Application Publication
(10) Pub. No.: US 2021/0042565 A1
(43) Pub. Date: Feb. 11, 2021

(54) METHOD AND DEVICE FOR UPDATING DATABASE, ELECTRONIC DEVICE, AND COMPUTER STORAGE MEDIUM

(71) Applicant: BEIJING SENSETIME TECHNOLOGY DEVELOPMENT CO., LTD., Beijing (CN)

(72) Inventors: Wei WU, Beijing (CN); Bo Li, Beijing (CN); Chengwei Gu, Beijing (CN)

(21) Appl. No.: 17/080,243

(22) Filed: Oct. 26, 2020

Related U.S. Application Data
(63) Continuation of application No. PCT/CN2019/092401, filed on Jun. 21, 2019.

(30) Foreign Application Priority Data
Nov. 1, 2018 (CN) 201811296570.4

(51) Int. Cl. G06K 9/62; G06F 16/583; G06F 16/51; G06F 16/54

(52) U.S. Cl. CPC G06K 9/6202; G06K 9/6215; G06F 16/54; G06F 16/583; G06F 16/51; G06K 9/623

(57) ABSTRACT

A method for updating a database includes: searching for at least two reference image templates matching an image of a target object from among multiple reference image templates included in a first database; performing filtering processing on the at least two reference image templates to obtain a filtered result, herein the filtered result includes at least one reference image template of the at least two reference image templates; and performing merging processing on the at least one reference image template included in the filtered result to obtain a merged image template.

### CROSS-REFERENCE TO RELATED APPLICATION

This application is a continuation of International Application No. PCT/CN2019/092401, filed on Jun. 21, 2019, which claims priority to Chinese Patent Application No. 201811296570.4, filed on Nov. 1, 2018. The disclosures of International Application No. PCT/CN2019/092401 and Chinese Patent Application No. 201811296570.4 are hereby incorporated in their entireties.

### BACKGROUND

With the development of the computer vision technology, image recognition has begun to be applied to various fields such as security and monitoring, facial unlocking, smart retails. During person identity recognition based on images, multiple person image templates are stored in a database in advance and identity recognition is performed on acquired person images based on the database. With the extension of application scenarios of identity recognition based on the images, a number of persons need to be recognized is increasing, and a fixed database cannot accommodate the needs of practical applications. However, it is very likely that images of a same person may be stored for more than one time during updating of the database, thus making the database become overly large in size and degrading system performance.

### SUMMARY

The disclosure relates to computer vision technology, and particularly, to a method and device for updating a database, an electronic device and a computer storage medium.

A technique for updating a database is provided in the embodiments of the disclosure.

An aspect according to the embodiments of the disclosure provides a method for updating a database, the method including: searching for at least two reference image templates matching an image of a target object from among multiple reference image templates included in a first database; performing filtering processing on the at least two reference image templates to obtain a filtered result, herein the filtered result includes at least one reference image template of the at least two reference image templates; and performing merging processing on the at least one reference image template included in the filtered result to obtain a merged image template.

Another aspect according to the embodiments of the disclosure provides a device for updating a database. The device includes: a memory storing processor-executable instructions; and a processor arranged to execute the stored processor-executable instructions to perform operations of: searching for at least two reference image templates matching an image of a target object from among a plurality of reference image templates comprised in a first database; performing filtering processing on the at least two reference image templates to obtain a filtered result, wherein the filtered result comprises at least one reference image template of the at least two reference image templates; and performing merging processing on the at least one reference image template comprised in the filtered result to obtain a merged image template.

Yet another aspect according to the embodiments of the disclosure provides a non-transitory computer-readable storage medium having stored thereon computer-readable instructions that, when executed by a processor, cause the processor to perform a method of updating a database, the method including: searching for at least two reference image templates matching an image of a target object from among a plurality of reference image templates comprised in a first database; performing filtering processing on the at least two reference image templates to obtain a filtered result, wherein the filtered result comprises at least one reference image template of the at least two reference image templates; and performing merging processing on the at least one reference image template comprised in the filtered result to obtain a merged image template.

The technical solutions of the present disclosure are described in detail below, with reference to the accompanying drawings and the embodiments.

### BRIEF DESCRIPTION OF THE DRAWINGS

The accompanying drawings constituting a part of the specification describe the embodiments of the present disclosure and are intended to explain the principles of the present disclosure together with the descriptions.

According to the following detailed descriptions, the present disclosure can be understood more clearly with reference to the accompanying drawings.

FIG. 1 is a schematic flowchart of a method for updating a database according to an embodiment of the disclosure.

FIG. 2 is another schematic flowchart of a method for updating a database according to an embodiment of the disclosure.

FIG. 3 is yet another schematic flowchart of a method for updating a database according to an embodiment of the disclosure.

FIG. 4 is yet another schematic flowchart of a method for updating a database according to an embodiment of the disclosure.

FIG. 5 is a schematic structural diagram of a device for updating a database according to an embodiment of the disclosure.

FIG. 6 is a schematic structural diagram of an electronic device according to an embodiment of the disclosure.

### DETAILED DESCRIPTION

Various exemplary embodiments of the present disclosure are now described in detail with reference to the accompanying drawings. It should be noted that, unless otherwise stated specifically, relative arrangement of the components and operations, the numerical expressions, and the values set forth in the embodiments are not intended to limit the scope of the present disclosure. In addition, it should be understood that, for ease of description, the size of each part shown in the accompanying drawings is not drawn in actual proportion. The following descriptions of at least one exemplary embodiment are merely illustrative actually, and are not intended to limit the present disclosure and the applications or uses thereof. Technologies, methods and devices known to a person of ordinary skill in the related art may not be discussed in detail, but such technologies, methods and devices should be considered as a part of the specification in appropriate situations. It should be noted that similar reference numerals and letters in the following accompanying drawings represent similar items. Therefore, once an item is defined in an accompanying drawing, the item does not need to be further discussed in the subsequent accompanying drawings.

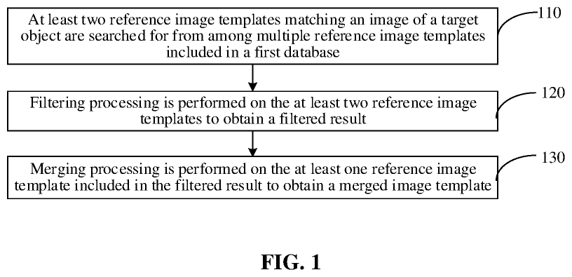

FIG. 1 is a schematic flowchart of a method for updating a database according to an embodiment of the disclosure. The method may be performed by any electronic device such as a terminal device, a server and a mobile device. The method includes operations 110 to 130.

In operation 110, at least two reference image templates matching an image of a target object are searched for from among multiple reference image templates included in a first database.

In the embodiment of the disclosure, the image of the target object is obtained. For example, the image of target object inputted by a user is received, the image of the target object is acquired by an image sensor or the image of the target object is received from other devices, etc. The image of the target object may refer to an image that includes at least a part of the target object such as a face image, a half-length portrait, or a body image of the target object. The image of the target object may be a stationary image or a video-frame image. For example, the image of the target object may be a video-frame image, an image frame coming from a video sequence of an image sensor, or a single image. Attributes, sources, acquisition manners and the like of the image of the target object are not limited in the embodiments of the disclosure.

Multiple reference image templates are stored in the first database. In some implementations, a reference image template stored in the first database may include an image and/or feature data. The feature data may include for example, but are not limited to, feature vectors, feature maps or the like, or the reference image template may further include other information. The reference image template may be inputted manually, obtained from other devices or generated dynamically during processing of an image or a video. For example, the reference image template is generated during registration of a user. For another example, the reference image template is generated in a procedure of processing a video acquired in real time, etc. The sources of the reference image template and information included by the reference image template are not limited in the embodiments of the disclosure.

In operation 110, the first database is searched in order to determine whether there is a reference image template matching the target object in the first database, and the search result obtained through the searching include at least two reference image templates that match the target object. In some implementations, a similarity between the image of the target object and a reference image template may be determined and whether the image of the target object matches the reference image template may be determined. In some implementations, a similarity threshold may be set, and it is determined whether the image of the target object matches the reference image template by comparing the similarity with the similarity threshold. For example, the similarities between the image of the target object and the multiple reference image templates included in the first database, such as the similarities between the image of the target object and a part or all of the multiple reference image templates, are determined; at least two reference image templates, whose respective similarities with the image of the target object are greater than the similarity threshold, are obtained from among the multiple reference image templates based on the similarity threshold, and the obtained at least two reference image templates are determined as the reference image templates matching the image of the target object. In some other implementations, the reference image templates matching the image of the target object are determined based on comparison of the similarities between the image of the target object and the multiple reference image templates. For example, the multiple reference image templates are sequenced according to a descending order of the similarities between the multiple reference image templates and the image of the target object, and the first k reference image templates in the sequence are determined as the search result, where k is a preset integer greater than or equal to 2. In some other implementations, the reference image templates matching the image of the target object are determined by combining the above two implementations. In other words, the first k reference image templates, that are selected from at least two reference image templates having similarities with the image of the target object greater than the similarity threshold, are determined as the search result, etc.

In the embodiment of the disclosure, the similarity between the image of the target object and the reference image template may be determined in multiple manners. For example, the image of the target object and a reference image template are inputted into a neural network to be processed, and an indication for indicating whether the image of the target object matches the reference image template are outputted. For another example, whether the image of the target object matches a reference image template are determined based on distances between feature data of the image of the target object and feature data corresponding to the reference image template. The embodiment of the disclosure is not limited thereto.

In some implementations, the reference image template includes an image, rather than the feature data. In this case, feature extraction may be firstly performed on the image included in the reference image template and the image of the target object respectively, to obtain the feature data of the reference image template and image reference data of the image of the target object, and whether the reference image template matches the image of the target object is determined based on a distance between the feature data of the reference image template and the image feature data. In some other implementations, the reference image template includes the feature data. In this case, the feature may be firstly extracted from the image of the target object to obtain the image reference data of the image of the target object, and whether the reference image template matches the image of the target object is determined based on a distance between the image feature data of the image of the target object and the feature data included in the reference image template. In some other implementations, the reference image template matching the image of the target object may be obtained in other searching manners. The embodiment of the disclosure is not limited thereto.

In operation 120, filtering processing is performed on the at least two reference image templates to obtain a filtered result.

The filtered result includes at least one reference image template of the at least two reference image templates, namely a part or all of the at least two reference image templates.

In some implementations, the filtering processing is performed on the at least two reference image templates based on the similarities between the at least two reference image templates obtained in the searching and the image of the target object or based on similarities between the at least two reference image templates obtained in the searching, etc. The embodiment of the disclosure is not limited thereto. In this case, the reference image templates that quite possibly correspond to a same target is obtained after the filtering and thus the multiple reference image templates in the first database that quite possibly correspond to the same target are merged to reduce the first database's diffusion rate. In some implementations, the filtered result includes a first reference image template or further includes a part of at least second or third reference image templates. The embodiment of the disclosure is not limited thereto.

In operation 130, merging processing is performed on the at least one reference image template included in the filtered result to obtain a merged image template.

In the embodiment of the disclosure, the merging processing is performed on the at least one reference image template included in the filtered result to obtain the merged image template. In some implementations, the at least one reference image template stored in the first database is replaced by the obtained merged image template, which effectively reduces the first database's diffusion rate.

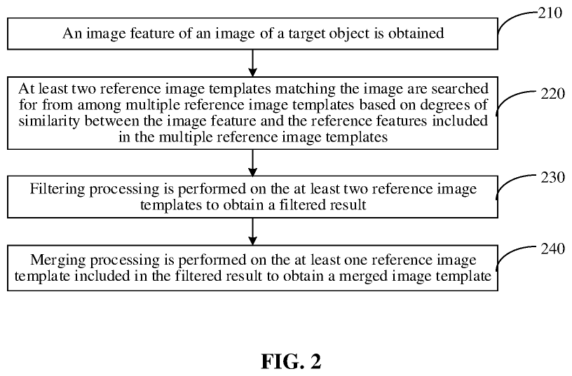

The method provided in the above embodiment of the disclosure is conducive to avoiding an unnecessary increase of the database's size and improving a system's performance FIG. 2 is another schematic flowchart of a method for updating a database according to an embodiment of the disclosure. It is assumed herein that reference image template includes reference feature. The embodiment of the disclosure is not limited thereto. The method includes operations 210 to 240.

In operation 210, an image feature of an image of a target object is obtained.

In some implementations, manners in which the image feature is obtained include but are not limited to that the image feature of the target object is received from other devices. For example, the image feature of the image is received from a terminal device such as a cell phone, a computer, a tablet computer. For another example, image is obtained (for example, the image is acquired by an image sensor or obtained from other device) and features are extracted from the image. In some implementations, the extraction of the feature from the image may be implemented through a convolutional neural network, other feature-extracting algorithms or other manners. The embodiment of the disclosure is not limited thereto.

In operation 220, the at least two reference image templates matching the image are searched for from among multiple reference image templates based on similarities or distances between the image feature and the reference features included in the multiple reference image templates.

In some implementations, the similarities between the image feature and the reference features rely on distances between the image feature and the reference features. The distances may include but are not limited to a cosine distance, an Euclidean distance, a Mahalanobis distance and the like. The shorter the distances between the image feature and the reference features are, the greater the similarities between the image feature and the reference features are. In some implementations, when the similarities between the image feature and the reference features satisfy a preset condition, it can be believed that the reference image templates including the reference features match the image. The preset condition includes but is not limited to a condition that the similarities are greater than or equal to a similarity threshold, a condition that the similarities are within a preset range, a condition that the similarities are among a first preset number of all obtained similarities or the like. The similarities between the image feature and the reference features may be determined based on other manners besides the distances between the image feature and reference features. How to determine the similarities between the image feature and the reference features is not limited in the embodiment of the disclosure.

In operation 230, filtering processing is performed on the at least two reference image templates to obtain a filtered result.

In operation 240, merging processing is performed on the at least one reference image template included in the filtered result to obtain a merged image template. In the embodiment of the disclosure, the reference image template includes the reference feature. Since a space occupied by feature data is smaller than a space occupied by the image and there is no need to extract features from the stored data in the searching, the searching is accelerated and a data processing efficiency is improved.

For example, the reference image template including the reference feature having a similarity with the image feature reaching the first similarity threshold is determined as the reference image template matching the image from among the multiple reference image templates. The first similarity threshold is set in order to obtain the reference image template matching the image, and the reference image template including the reference feature having a similarity with the image feature reaching the first similarity threshold is determined as the reference image template matching the image. The first similarity threshold may be set according to actual situations. For example, if the first similarity threshold is set to be 0.7, similarities between four reference image templates (a reference image template 1, a reference image template 2, a reference image template 3 and a reference image template 4) and the image are 0.6, 0.9, 0.7 and 0.3 respectively, the reference image templates 2 and 3 are determined as the reference image templates matching the image after a comparison between the similarities and the first similarity threshold.

For another example, first k of the multiple reference image templates whose reference features have greatest similarities with the image feature are determined as the reference image templates matching the image, where k is an integer greater than or equal to 2.

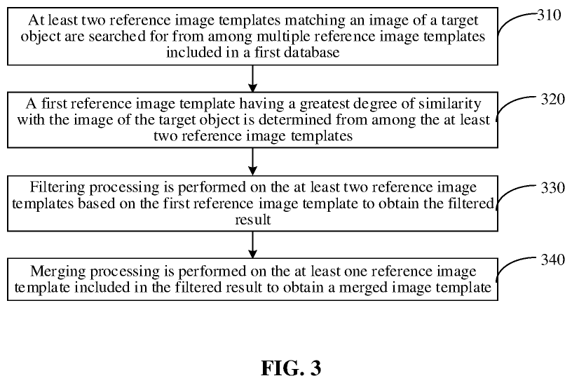

FIG. 3 is yet another schematic flowchart of a method for updating a database according to an embodiment of the disclosure. The method includes operations 310 to 340.

In operation 310, at least two reference image templates matching an image of a target object are searched for from among multiple reference image templates included in a first database.

In operation 320, a first reference image template that has a greatest similarity with the image of the target object is determined from among the at least two reference image templates.

In some implementations, the at least two reference image templates are put in an order such as a descending or an ascending order according to the similarities between the at least two reference image templates and the image, which makes the first reference image template having the greatest similarity with the image of the target object determined more quickly. The ordering based on the similarities may be skipped so that the first reference image template is directly determined based on the similarity between each of the at least two reference image templates and the image of the target object. However, a manner in which the first reference image template is determined is not limited in the embodiment of the disclosure.

In operation 330, filtering processing is performed on the at least two reference image templates based on the first reference image template to obtain the filtered result.

In the embodiment of the disclosure, the filtered result includes at least one reference image template that may include the first reference image template or further include one or more second reference image templates. The embodiment of the disclosure is not limited thereto.

In some implementations, one or more of at least one second reference image template, which has a similarity with the first reference image template reaching a third similarity threshold, are added into the filtered result. The at least one second reference image template is one or more of the at least two reference image templates other than the first reference image template.

In an embodiment of the disclosure, through the third similarity threshold, the reference image templates (including the first reference image template and the at least one second reference image template) that have greater similarities are determined as the filtered result from among a search result. In some implementations, since the filtered result needs to be merged, i.e., it is necessary to determine during the filtering whether the reference image templates included in the filtered result correspond to a same target, the third similarity threshold is usually a relatively great value such as a value greater than a first similarity threshold and/or a second similarity threshold, so as to avoid an error resulted from merging of reference image templates of different targets due to small similarities. In some other implementations, a first updated reference feature is obtained based on the first reference image template and the image feature of the image, and one or more of at least one second reference image template, which has a similarity with the first updated reference feature reaching the third similarity threshold, are added into the filtered result.

In some other implementations, a second updated reference feature of each of the at least one second reference image template is obtained based on the second reference image template and the image feature of the image, and one or more of the at least one second reference image template, whose corresponding second updated reference features have respective similarities with the reference feature of the first reference image template reaching the third similarity threshold, are added into the filtered result.

In some other implementations, the first updated reference feature is obtained based on the first reference image template and the image feature of the image; the second updated reference feature of each of the at least one second reference image template is obtained based on the second reference image template and the image feature of the image; and one or more of the at least one second reference image template, whose corresponding second updated reference features have the respective similarities with the reference feature of the first reference image template reaching the third similarity threshold, are added into the filtered result. It should be understood that above descriptions are given based on examples where it is judged whether the third similarity threshold is reached. In some implementations, the filtering may be performed based on other standards. For example, a first certain number of the second reference image templates in the at least one second reference image templates sequenced in a descending order of similarities are added in the filtered result. The embodiments of the disclosure are not limited thereto.

In operation 340, merging processing is performed on the at least one reference image template included in the filtered result to obtain a merged image template.

In some implementations, the merged template's reference feature is obtained based on the reference feature(s) of the at least one reference image template included in the filtered result and the image feature of the image of the target object, and optionally, other information of the merged template may be same as or different from that of the first reference image template. In other words, the reference feature of the first reference image template may be updated, the first reference image template with the updated reference feature may be determined as the merged image template, and then other possible reference image templates included in the filtered result are deleted. Alternatively, all reference image templates included in the filtered result are deleted and the merged image template is added in the first database. The embodiments of the disclosure are not limited thereto.

In the embodiment of the disclosure, the reference image templates included in the filtered result obtained in the filtering may be considered to correspond to a same target. The reference image templates in the obtained filtered result are merged into the merged image template so that the target only corresponds to one or a small number of image templates in the first database, it is thus possible to decrease the number of the templates included in the database, increase a search efficiency and improve a system's overall performance.

In some implementations, operation 330 includes: the first updated reference feature is obtained based on the first reference image template and the image feature of the image of the target object; and the filtering processing is performed on the at least one second reference image template based on similarities between the reference features included in the at least one second reference image template and the first updated reference feature to obtain the filtered result. In the embodiment of the disclosure, firstly, the first updated reference feature is obtained based on the first reference image template and the image feature of the image of the target object. In some implementations, at least two pieces of first feature data corresponding to the first reference image template are obtained. The reference feature included in the first reference image template is obtained based on the at least two pieces of first feature data. Then, the first updated reference feature is determined based on the image feature of the image and the at least two pieces of first feature data. For example, an average feature is obtained by performing averaging processing on the at least two pieces of first feature data and the image feature; then the at least two first updated features are selected from among the at least two pieces of first feature data and the image feature based on a distance between each of the at least two pieces of first feature data and the average feature as well as a distance between the image feature and the average feature; finally the first updated reference feature is determined based on the at least two first updated features.

The first feature data are original data of the first reference image template. The at least two first updated features are selected from among the at least two pieces of first feature data and the image feature, and taken as updated original data. An updated reference feature is obtained based on the updated original data. In some implementations, a feature that is relatively close to the average feature is selected from among the at least two pieces of first feature data and the image feature, and taken as the first updated features. For example, a first certain number of the features sequenced according to an ascending order of distances from the average feature, features whose distances from the average feature are less than a specific value or the like are selected. The embodiments of the disclosure are not limited thereto.

After the first updated reference feature is obtained, the filtering processing is performed on the at least one second reference image template based on the similarities between the reference features included in the at least one second reference template and the first updated reference feature. In some implementations, one or more of the at least one second reference image template, whose reference features have respective similarities with the first updated reference feature satisfying a first condition, are added into the filtered result. In some implementations, the first condition includes but is not limited to: the similarities with the first updated reference feature are greater than or equal to the third similarity threshold.

The first updated reference feature in the embodiment of the disclosure is obtained based on fusion of the first reference image template and the image feature. Then, by determining the similarities between the second reference image templates and the first updated reference feature, a relationship between the image feature after the fusion and the search results other than a maximum search result (the first reference image template corresponding to a maximum similarity) may be determined. In some implementations, the similarities between the reference features and the first updated reference feature may be determined based on distances between the reference features and the first updated reference feature, such as Euclidean distances, cosine distances, Mahalanobis distances. Manners in which the similarities are obtained are not limited in the embodiments of the disclosure.

In the embodiment of the disclosure, since the filtered result needs to be merged, i.e., it is necessary to determine during the filtering whether the reference image templates included in the filtered result correspond to a same target, the third similarity threshold is usually a relatively great value, so as to avoid an error resulted from merging of reference image templates of different targets due to small similarities. In some implementations, the third similarity threshold may be set to be greater than the first similarity threshold that is used for the searching. For example, when the third similarity threshold is a relatively great value and the similarities are greater than or equal to the third similarity threshold, it is indicated that the similarities between the reference features of the obtained second reference image templates and the first updated reference feature are relatively great values, and thus the second reference image templates may correspond to a same target.

In some implementations, the operation of determining the first updated reference feature based on the image feature of the image and the at least two pieces of first feature data includes: the at least two first updated features are selected from among the image feature of the image and the at least two pieces of first feature data. In some implementation, the average feature is obtained by performing the averaging processing on the image feature of the image and the at least two pieces of first feature data, and the at least two first updated features are determined based on a distance between the image feature of the image and the average feature as well as the distances between the at least two pieces of first feature data and the average feature. For example, two first updated features at a shortest distance from the average feature are selected. After the at least two first updated features are obtained, the first updated reference feature is obtained based on the at least two first updated features. For example, the first updated reference feature is obtained in a manner such as averaging the at least two first updated features and performing weighted averaging on the at least two first updated features.

In some implementations, the reference feature included in the first reference image template is obtained by performing the averaging processing on the at least two pieces of first feature data. The operation of obtaining the first updated reference feature based on the at least two first updated features includes: the averaging processing is performed on the at least two first updated features to obtain the first updated reference feature.

In the embodiment of the disclosure, the reference feature is obtained by performing the averaging processing on the extracted at least two pieces of first feature data. The averaging processing may be averaging of a sum of the at least two pieces of first feature data or weighted averaging of the at least two pieces of first feature data. The manner of performing the averaging processing is not limited in the embodiment of the disclosure. When the first updated reference feature is obtained, the at least two first updated features are determined as the at least two pieces of first feature data for obtaining the reference feature, that is to say, the averaging processing for obtaining the first updated reference feature is same as the averaging processing for obtaining the reference feature. In some implementations, the operation of selecting the at least two first updated features from among the image feature of the first image and the at least two pieces of reference feature data includes: the averaging processing is performed on the image feature and the at least two pieces of first feature data to obtain a first average feature; and the at least two first updated features are selected from among the image feature and the at least two pieces of first feature data based on a distance between the image feature and the first average feature as well as a distance between each of the at least two pieces of first feature data and the first average feature.

In the embodiment of the disclosure, the averaging processing is performed on the image feature and the at least two pieces of first feature data. With the obtained first average feature determined as a middle point, at least two pieces of feature data (including the first feature data or the image feature) that are nearest the middle point are determined as the first updated feature from among the image feature and the at least two pieces of first feature data based on the distance between the image feature and the middle point as well as the distances between the at least two pieces of first feature data and the middle point.

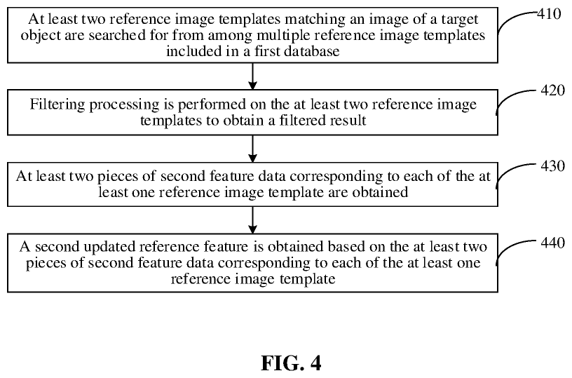

FIG. 4 is yet another schematic flowchart of a method for updating a database according to an embodiment of the disclosure. The method includes operations 410 to 440.

In operation 410, at least two reference image templates matching an image of a target object are searched for from among multiple reference image templates included in a first database. In operation 420, filtering processing is performed on the at least two reference image templates to obtain a filtered result. In operation 430, at least two pieces of second feature data corresponding to each of the at least one reference image template are obtained. In some implementations, the reference image template is obtained by performing averaging processing on the at least two pieces of second feature data. The second feature data may be considered to be original data and a third reference image template is average data obtained by performing the averaging processing on the original data. In operation 440, a second updated reference feature is obtained based on the at least two pieces of second feature data corresponding to each of the at least one reference image template.

In some implementations, at least two pieces of feature data are obtained by making a fusion selection based on the at least two pieces of second feature data and the at least two pieces of second feature data corresponding to the reference image templates, and then the second updated reference feature is obtained by performing the averaging processing on the obtained at least two pieces of feature data. In some implementations, at least two second updated features are selected from among multiple pieces of second feature data corresponding to the at least one reference image template and at least two pieces of first feature data, and then the second updated reference feature is obtained based on the at least two updated features. For example, a “2-from-4” fusion selection is performed on the two pieces of second feature data corresponding to the reference image templates and two pieces of first feature data, which means that two pieces of feature data are selected from 4 pieces of feature data as original data of the second updated reference feature, and then the second updated reference feature is obtained by averaging the original data.

In some implementations, the operation of selecting the at least two second updated features from among the multiple pieces of second feature data corresponding to the at least one reference image template includes: a second average feature is determined based on the multiple pieces of second feature data corresponding to the at least one reference image template; and the at least two second updated features are selected from among the multiple pieces of second feature data corresponding to the at least one reference image template based on a distance between each of the multiple pieces of second feature data corresponding to the at least one reference image template and the second average feature.

In the embodiment of the disclosure, the second average feature is obtained by performing the averaging processing on the multiple pieces of second feature data, and the at least two pieces of second feature data are selected and determined as the second updated features based on the distances between the second feature data and the second average feature such as Euclidean distances, cosine distances, Mahalanobis distances. In some implementations, the at least two pieces of second feature data that are at a relatively short distance from the second average feature are determined as the second updated features. For examples, two pieces of second feature data that are at a shortest distance from the second average feature are determined as the second updated features to implement the selection of the feature data.

In some implementations, the operation of obtaining the at least two pieces of second feature data corresponding to each of the at least one reference image template includes: the at least two pieces of second feature data corresponding to each of the at least one reference image template included in the filtered result are obtained from a second database.

In the embodiment of the disclosure, the at least two pieces of first feature data correspond to a first reference image template. In some implementations, each reference image template in the first database corresponds to at least two pieces of feature data, and not all the feature data are stored in the first database in order to make the first database updated more quickly. In the embodiment of the disclosure, the reference image templates and the first feature data are respectively stored in a separate database, which makes the processing faster. Since the first feature data are only used in the merging and the fusion, the first feature data are stored separately in the second database. If the reference image templates and the first feature data are stored together in the first database, the first database will be so large that the processing will become slow.

In some implementation, the method in the embodiment of the disclosure further includes: the at least one reference image template stored in the first database is replaced by a merged image template.

In some implementations, at least one reference image template of the at least two reference image templates obtained in the searching are replaced by the merged image template. For example, the first reference image template is replaced by the merged image template, or reference image templates of a same target object corresponding to an image are replaced by the merged image template to implement an operation of replacing multiple reference image templates with the merged image template. In the embodiment of the disclosure, the replacement operation implements the update of the database based on the image of the target object. The replacement of the at least one reference image template with the merged image template obtained based on the image's feature decreases a number of the reference image templates in the first database as well as the first database's diffusion rate.

In one or more embodiments, the method further includes: before performing the filtering processing on the at least two reference image templates to obtain the filtered result, it is determined whether similarities between the at least two reference image templates and the image satisfy a filtering condition.

The operation that the filtering processing is performed on the at least two reference image templates to obtain the filtered result includes: in response to that the similarities between the at least two reference image templates and the image satisfy the filtering condition, the filtering processing is performed on the at least two reference image templates to obtain the filtered result.

In some implementations, the filtering condition includes but is not limited to: a maximum of the similarities between the at least two reference image templates and the image is greater than or equal to a second similarity threshold. In the embodiment of the disclosure, the similarities between the at least two reference image templates and the image are compared with the second similarity threshold. For example, the maximum of the similarities between the at least two reference image templates and the image is compared with the second similarity threshold; when the filtering condition is satisfied, the at least two reference image templates obtained in the searching are determined as reference image templates that are more similar to the image. Some of the reference image templates correspond to a same target object as the image, thus the features corresponding to the same target object needs to be processed in order to reduce the first database's diffusion rate. In the embodiment of the disclosure, the first database's diffusion rate is decreased by filtering the at least two reference image templates obtained in the searching and then performing the processing such as the merging processing on the filtered result. In some implementations, the second similarity threshold is greater than a first similarity threshold used for the searching. Whether a reference feature image corresponding to the target object of the image has already been stored in the first database may be determined through the second similarity threshold. The second similarity threshold is used for selection from among the reference image templates obtained in the searching based on the first similarity threshold. The second similarity threshold may be set to be greater than the first similarity threshold to ensure an accuracy in the selection.

In some implementations, the method in the embodiment of the disclosure further includes: in response to that the similarities between the at least two reference image templates and the image do not satisfy the filtering condition, a reference image template corresponding to the image is added into the first database.

When the maximum does not satisfy the filtering condition, it is indicated that all search results have small similarities with the image and it can be considered that the reference image templates of the image corresponding to the target object are not stored in the first database. In some implementations, the reference image templates corresponding to the image are created in the first database. Since the image feature corresponding to the image is an original feature, the image feature is added into the first database after being processed. In some implementations, the averaging processing may be performed on image features of at least two images corresponding to the target object and feature data obtained after the averaging processing are stored in the first database. In some implementations, the method may further include: after the feature data are stored, person identification numbers corresponding to the feature data are created. Each piece of reference image template data in the first database corresponds to an person identification number and a piece of feature data.

In an optional application example, two databases are set up in a device, including: a dynamic face database and an original database. The dynamic face database corresponds to the first database in the above embodiments where multiple reference image templates including reference features are stored. The original database corresponds to the second database in the above embodiments where original feature data of the dynamic face database are stored. Each reference image template corresponds to two or more original face features in the original database. In a following example, it is assumed that the reference image template corresponds to two original face features in the original database and the reference features are obtained by performing averaging processing on the two original face features. Accordingly, the reference feature is referred to as an average feature. In addition, a correspondence relationship between an item in the dynamic face database and an item in the original database is recorded, and both of the items correspond to a same person. In the following example, a same person identification number (person_id) is used to mark the items corresponding to the same person in the two databases. In this way, an original feature corresponding to the average feature in the first database is searched for from among the second database based on the person identification number.

The example of a process of updating the database is shown as follows.

1) A face feature of an acquired image is extracted, and the dynamic face database is searched to obtain a search result. Templates in the dynamic face database whose similarities with the acquired image reach a first similarity threshold (threshold1) are added into the search result.

In some implementations, if the search result is empty, template data corresponding to the acquired image is added into both the dynamic face database and the original database, and the process ends with storing, in a person_feature mapping table, a correspondence relationship between a person identification number allocated to the template data and the face feature.

In some implementations, if the search result includes k templates, following operations 2) to 6) are performed directly, or performed after the k templates included in the search result are sequenced according to a descending order of similarities between the k templates and the acquired image.

2) A similarity between a template, having a greatest similarity with the acquired image (i.e., the first reference image template, such as the 1^{st} template after the sequencing) among the search result, and the acquired image is compared with a second similarity threshold (threshold2).

In some implementations, if the similarity is less than the second similarity threshold, the template data corresponding to the acquired image is added into the dynamic face database and the original database, the correspondence relationship between the person identification number allocated to the template data and the face feature is stored in the person_feature mapping table, and the process ends.

3) If the similarity between the 1^{st} template and the acquired image is greater than the second similarity threshold (threshold2), anti-diffusion processing is performed, i.e., the following operations 4) to 6) are performed.

4) Two original features corresponding to the 1^{st} template are obtained from the original database. An operation of selecting two from three is performed on the two original features and the face feature of the acquired image (e.g., the image feature of the image of the target object), that is to say, two features are selected from among the two original features and the face feature of the acquired image; and averaging processing is performed on the two features to obtain an average feature (the first updated reference feature).

5) Similarities between k−1 templates following the 1^{st} template (e.g., the second reference image templates) and the average feature are determined. The similarities are compared with a third similarity threshold (threshold3) to obtain a filtered result. For example, one or more of the k−1 templates whose similarities with the average feature are greater than threshold3 are added into the filtered result.

6) The filtered result is traversed, and an operation of “selecting two from among four” is performed on the two face features selected in operation 4) and the two original features corresponding to each template in the filtered result to finally obtain two face features. The averaging processing is performed on the finally obtained two face features to obtain an updated feature (i.e., a second updated reference feature). The updated feature is utilized to perform a feature-updating operation on the 1^{st} template in the dynamic feature database, and meanwhile, the original database and information in the mapping table person_feature are updated, and other templates in the filtered result are deleted from the dynamic feature database and the original database.

It should be understood that the above example is not intended to limit the disclosure but is used to help those skilled in the art better understand the technical solutions of the disclosure. Those skilled in the art may also make various changes or substitutions based on the above example or choose not to perform one or more operations in the example.

Those of ordinary skills in the art may understand that, all or a part of the operations of the above method embodiments may be completed through hardware related to programs and instructions. The foregoing programs may be stored in a computer-readable storage medium. When executed, the programs perform the operations of the above method embodiments. The foregoing storage medium includes various mediums capable of storing program codes such as a Read-Only Memory (ROM), a Random Access Memory (RAM), a magnetic disk and a optical disk.

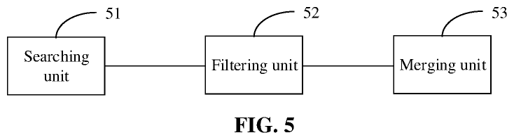

FIG. 5 is a schematic structural diagram of a device for updating a database according to an embodiment of the disclosure. The device in the embodiment may be used to implement each of the above method embodiments of the disclosure. As illustrated in FIG. 5, the device includes a searching unit 51, a filtering unit 52 and a merging unit 53.

The searching unit 51 is configured to search for at least two reference image templates matching an image of a target object from among multiple reference image templates included in a first database.

In the embodiment of the disclosure, the image of the target object is obtained. For example, the image of target object inputted by a user is received, the image of the target object is acquired by an image sensor or the image of the target object is received from other devices, etc. The image of the target object may refer to an image that includes at least a part of the target object such as a face image, a half-length portrait, or a body image of the target object. The image of the target object may be a stationary image or a video-frame image. For example, the image of the target object may be a video-frame image, an image frame coming from a video sequence of an image sensor, or a single image. Attributes, sources, acquisition manners and the like of the image of the target object are not limited in the embodiments of the disclosure.

The filtering unit 52 is configured to perform filtering processing on the at least two reference image templates to obtain a filtered result.

The filtered result includes at least one reference image template of the at least two reference image templates.

The merging unit 53 is configured to perform merging processing on the at least one reference image template included in the filtered result to obtain a merged image template. The device provided based on the above embodiments is beneficial to avoiding an unnecessary increase of the database's size and enhancing a system's performance.

It can be assumed that the reference image template includes a reference feature in some implementations but the embodiment of the disclosure is not limited thereto.

the searching unit 51 is configured to obtain an image feature of the image of target object; and

search for the at least two reference image templates matching the image from among the multiple reference image templates based on similarities between the image feature and the reference features included in the multiple reference image templates.

In the embodiment of the disclosure, the reference image template includes the reference feature. Since a space occupied by feature data is smaller than a space occupied by the image and there is no need to extract features from the stored data in the searching, the searching is accelerated and a data processing efficiency is improved.

In some implementations, the searching unit 51 is configured to determine, as the at least two reference image templates matching the image, reference image templates including reference features having respective similarities with the image feature reaching a first similarity threshold from among the multiple reference image templates when searching for the at least two reference image templates matching the image from among the multiple reference image templates based on the similarities between the image feature and the reference features included in the multiple reference image templates.

In some implementations, the filtering unit 52 includes a maximum-similarity module and a filtering processing module. The maximum-similarity module is configured to determine a first reference image template from among the at least two reference image templates that has a greatest similarity with the image of the target object. The filtering processing module is configured to perform the filtering processing on the at least two reference image templates based on the first reference image template to obtain the filtered result.

In the embodiment of the disclosure, firstly the first updated reference feature is determined based on the first reference image template and the image feature of the image of the target object. In some implementations, at least two pieces of first feature data corresponding to the first reference image template are obtained. The reference feature included in the first reference image template is obtained based on the at least two pieces of first feature data. Then the first updated reference feature is determined based on the image feature of the image and the at least two pieces of first feature data. For example, an average feature is obtained by performing averaging processing on the at least two pieces of first feature data and the image feature; then the at least two first updated features are selected from among the at least two pieces of first feature data and the image feature based on a distance between each of the at least two pieces of first feature data and the average feature as well as a distance between the image feature and the average feature; finally the first updated reference feature is determined based on the at least two first updated features.

In some implementations, the filtering processing module is configured to add one or more of at least one second reference image template, which have respective similarities with the first reference image template reaching a third similarity threshold, into the filtered result. The at least one second reference image template is one or more of the at least two reference image templates other than the first reference image template.

In some implementations, the filtering processing module is configured to obtain a first updated reference feature based on the first reference image template and the image feature of the image of target object and perform the filtering processing on the at least one second reference image template based on similarities between the reference features included in the at least one second reference image template and the first updated reference feature to obtain the filtered result. The at least one second reference image template is one or more of the at least two reference image templates other than the first reference image template.

In some implementations, the filtering processing module is configured to add one or more of the at least one second reference image templates whose reference features have respective similarities with the first updated reference feature satisfying a first condition, into the filtered result, when performing the filtering processing on the at least one second reference image template based on the similarities between the reference features included in the at least one second reference image template and the first updated reference feature to obtain the filtered result.

In some implementations, the first condition includes: the similarities with the first updated reference feature are greater than or equal to a third similarity threshold.

In some implementations, the third similarity threshold is greater than the first similarity threshold used for the searching.

In some implementations, the filtering processing module is configured to obtain at least two pieces of first feature data corresponding to the first reference image template and determine the first updated reference feature based on the image feature of the image and the at least two pieces of first feature data when obtaining the first updated reference feature based on the first reference image template and the image feature of the image of target object. Reference feature included in the first reference image template is obtained based on the at least two pieces of first feature data.

In some implementations, the filtering processing module is configured to select at least two first updated features from among the image feature of the image and the at least two pieces of first feature data and obtain the first updated reference feature based on the at least two first updated features when determining the first updated reference feature based on the image feature of the image and the at least two pieces of first feature data.

In some implementations, the reference feature included in the first reference image template is obtained by performing averaging processing on the at least two pieces of first feature data. The filtering processing module is configured to perform the averaging processing on the at least two first updated features to obtain the first updated reference feature when obtaining the first updated reference feature based on the at least two first updated features.

In some implementations, the filtering processing module is configured to perform the averaging processing on the image feature and the at least two pieces of first feature data to obtain a first average feature and select the at least two first updated features from among the image feature and the at least two pieces of first feature data based on the image feature and a distance between each of the at least two pieces of first feature data and the first average feature when selecting the at least two first updated features from among the image feature of the first image and the at least two pieces of reference feature data.

In some implementations, the merging unit 53 includes a feature data obtaining module and a feature updating module. The feature data obtaining module is configured to obtain at least two pieces of second feature data corresponding to each of the at least one reference image template included in the filtered result. The reference features included in the reference image templates are obtained based on the at least two pieces of second feature data corresponding to the reference image templates. The feature updating module is configured to obtain a second updated reference feature based on the at least two pieces of second feature data corresponding to each of the at least one reference image template. The merged image template includes the second updated reference feature.

In some implementations, at least two pieces of feature data are obtained by making a fusion selection from among the at least two pieces of second feature data and the at least two pieces of second feature data corresponding to the reference image templates and then the second updated reference feature is obtained by performing the averaging processing on the obtained at least two pieces of feature data. In some implementations, at least two second updated features are selected from among multiple pieces of second feature data corresponding to the at least one reference image template and at least two pieces of first feature data, and then the second updated reference feature is obtained based on the at least two updated features. For example, a “2-from-4” fusion selection is made from among the two pieces of second feature data corresponding to the reference image templates and two pieces of first feature data, which means that two of 4 pieces of feature data are selected as original data of the second updated reference feature and then the second updated reference feature is obtained by averaging the original data.

In some implementations, the feature updating module is configured to select the at least two second updated features from among multiple pieces of second feature data corresponding to the at least one reference image template and obtain the second updated reference feature based on the at least two second updated features.

In some implementations, the feature updating module is configured to determine a second average feature based on the multiple pieces of second feature data corresponding to the at least one reference image template and select the at least two second updated features from among the multiple pieces of second feature data corresponding to the at least one reference image template based on a distance between each of the multiple pieces of second feature data corresponding to the at least one reference image template and the second average feature when selecting the at least two second updated features from among the multiple pieces of second feature data corresponding to the at least one reference image template.

In some implementations, the feature data obtaining module is configured to obtain, from a second database, the at least two pieces of second feature data corresponding to each of the at least one reference image template included in the filtered result.

In some implementations, the device in the embodiment of the disclosure further includes a replacing unit, configured to replace the at least one reference image template stored in the first database with the merged image template.

In some implementations, the device further includes a condition determining unit configured to determine whether a maximum of similarities between the at least two reference image templates and the image satisfy a filtering condition. The filtering unit 52 is perform the filtering processing on the at least two reference image templates to obtain the filtered result in response to that the similarities between the at least two reference image templates and the image satisfy the filtering condition.

In some implementations, the filtering condition includes but is not limited to: a maximum of the similarities between the at least two reference image templates and the image is greater than or equal to a second similarity threshold. In the embodiment of the disclosure, the similarities between the at least two reference image templates and the image are compared with the second similarity threshold. For example, when the comparison between the maximum of the similarities between the at least two reference image templates and the image proves the filtering condition to be satisfied, the at least two reference image templates obtained in the searching are determined as reference image templates that are more similar to the image. Some of the reference image templates correspond to a same target object as the image, thus the features corresponding to the same target object needs to be processed in order to reduce the first database's diffusion rate. In the embodiment of the disclosure, the first database's diffusion rate is decreased by filtering the at least two reference image templates obtained in the searching and then performing the processing such as the merging processing on the filtered result.

In some implementations, the second similarity threshold is greater than the first similarity threshold used for the searching.

In some implementations, the condition determining unit is further configured to add a reference image template corresponding to the image into the first database in response to that the similarities between the at least two reference image templates and the image do not satisfy the filtering condition.

Another aspect according to the embodiments of the disclosure provides an electronic device including a processor. The processor includes the device for updating the database according to any one of the above embodiments.

Another aspect according to the embodiments of the disclosure provides an electronic device. The electronic device includes a memory configured to store executable instructions and a processor that is configured to communicate with the memory to execute the executable instructions so that operations of the method for updating the database provided by the any one of the above embodiments are completed.

Another aspect according to the embodiments of the disclosure provides a computer-readable storage medium configured to store computer-readable instructions that, when executed, perform operations of the method for updating the database provided by any one of the above embodiments.

Another aspect according to the embodiments of the disclosure provides a computer program product including computer-readable codes that, when executed on a device, cause a processor in the device to perform instructions of the method for updating the database provided by any one of the above embodiments.

Yet another aspect according to the embodiments of the disclosure provides another computer program product configured to store computer-readable instructions that, when executed, cause the computer to perform operations of the method for updating the database provided by any one of the above embodiments.

The computer program product may be implemented using software, hardware, or a combination of the software and the hardware. In one optional example, the computer program product may be embodied as a software product such as an SDK.

A method and device for updating a database, an electronic device, a computer storage medium, and a computer program product are further provided in the embodiment of the disclosure, in which at least one reference image template matching an image of a target object is searched for from among multiple reference image templates included in a first database and the first database is updated based on similarities between the at least one reference image template and the image.

In some embodiments, a network-acquiring instruction or an image-processing instruction may be an invoking instruction. A first device may instruct a second device to perform the network acquisition or the image processing in an invoking manner. Accordingly, in response to receiving the invoking instruction, the second device may perform operations and/or processes in any embodiment in the above network-acquiring method or the image-processing method.

In the embodiments of the disclosure, at least two reference image templates matching an image of a target object are searched for from among multiple reference image templates included in a first database; filtering processing is performed on the at least two reference image templates to obtain a filtered result, herein the filtered result includes at least one reference image template of the at least two reference image templates; and merging processing is performed on the at least one reference image template included in the filtered result to obtain a merged image template. The above operations are conductive to avoiding an unnecessary increase of a size of a database and improving system performance.

It should be understood that the term such as “first” and “second” are merely used for the sake of differentiation and is not intended to limit the embodiments of the disclosure. In the embodiments of the disclosure, “a plurality of” in the disclosure may mean “two or more” and “at least one” may mean “one, two or more”. The number of parts, data or structures mentioned in the disclosure is equal to or greater than one unless definite limitation is imposed, or opposite enlightenment is given in the context. The description of each embodiment puts emphasis on differences among the embodiments, while same or similar contents may be cross-referenced among the embodiments and will not be elaborated for the sake of brevity.

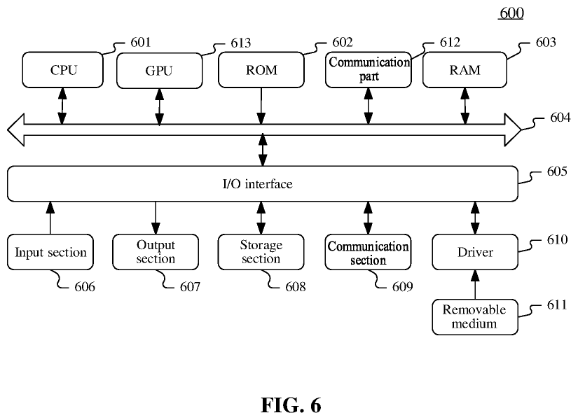

An electronic device such as a mobile terminal, a Personal Computer (PC), a tablet computer, a service is further provided in the embodiments of the disclosure. A schematic structural diagram of an electronic device 600 provided in the embodiments of the disclosure is illustrated in the FIG. 6 below. As illustrated in FIG. 6, the electronic device 600 includes one or more processors, a communication part, and the like. The one or more processors may be one or more Central Processing Units (CPUs) 601 and/or one or more Graphic Processing Units (GPUs) 613 or the like, and the processors may perform various appropriate actions and processing according to executable instructions stored in an ROM 602 or executable instructions loaded from a storage section 608 to an RAM 603. The communication part 612 may include, but is not be limited to, a network card. The network card may include, but is not be limited to, an Infiniband (IB) network card.

The processor may communicate with the ROM 602 and/or the RAM 603, to execute executable instructions. The processor is connected to the communication part 612 via a bus 604, and communicates with other target devices via the communication part 612, thereby implementing operations corresponding to any method provided in embodiments of the present disclosure. For example, at least two reference image templates matching an image of a target object are searched for from among multiple reference image templates included in a first database; filtering processing is performed on the at least two reference image templates to obtain a filtered result, herein the filtered result includes at least one reference image template of the at least two reference image templates; and merging processing is performed on the at least one reference image template included in the filtered result to obtain a merged image template. In addition, the RAM 603 further may store various programs and data required for operations of an apparatus. The CPU 601, the ROM 602, and the RAM 603 are connected to each other via the bus 604. In the presence of the RAM 603, the ROM 602 is an optional module. The RAM 603 stores executable instructions, or writes the executable instructions into the ROM 602 when running. The executable instructions cause the CPU 601 to execute operations to execute operations corresponding to the above communication method. An Input/Output (I/O) interface 605 is also connected to the bus 604. The communication part 612 may be configured integrally, and may also be configured to have multiple sub-modules (for example, multiple IB network cards) connected to the bus.

The following components are connected to the I/O interface 605: an input section 606 including a keyboard, a mouse, and the like; an output section 607 including a Cathode-Ray Tube (CRT), a Liquid Crystal Display (LCD), a speaker, and the like; a storage section 608 including a hard disk and the like; and a communication section 609 of a network interface card including an LAN card, a modem, and the like. The communication section 609 performs communication processing via a network such as the Internet. A drive 610 is also connected to the I/O interface 605 according to requirements. A removable medium 611 such as a magnetic disk, an optical disk, a magneto-optical disk, a semiconductor memory is installed on the drive 610 according to requirements, so that a computer program read from the removable medium is installed on the storage section 608 according to requirements.

It should be noted that, the architecture illustrated in FIG. 6 is merely an optional implementation. During practice, the number and types of the components in FIG. 6 may be selected, decreased, increased, or replaced according to actual requirements. Different functional components may be configured respectively or integrally or the like. For example, the GPU 613 and the CPU 601 may be configured respectively. For another example, the GPU 613 may be integrated on the CPU 601. The communication part may be configured respectively, and may also be configured integrally on the CPU 601 or the GPU 613 or the like. These alternative implementations all fall within the scope of protection of the present disclosure.

Particularly, according to the embodiments of the present disclosure, the process described below with reference to a flowchart may be implemented as a computer software program. For example, the embodiments of the present disclosure include a computer program product, which includes a computer program tangibly included in a machine-readable medium. The computer program includes a program code for performing operations shown in the flowchart. The program code may include instructions for correspondingly performing operations in the method provided by the disclosure. For example, the at least two reference image templates matching the image of the target object are searched for from among the multiple reference image templates included in the first database; the filtering processing is performed on the at least two reference image templates to obtain the filtered result, herein the filtered result includes the at least one reference image template of the at least two reference image templates; and the merging processing is performed on the at least one reference image template included in the filtered result to obtain the merged image template. In such embodiments, the computer program may be downloaded and installed from the network through the communication section 609, and/or may be installed from the removable medium 611. The computer program, when executed by the CPU 601, executes operations of the above instructions limited by the methods in the present disclosure.

The methods and the devices in the disclosure may be implemented in many manners. For example, the methods and the devices in the disclosure may be implemented with software, hardware, firmware, or any combination of software, hardware, and firmware. The foregoing sequence of the operations of the method is merely for description, and unless otherwise stated particularly, is not intended to limit the operations of the method in the disclosure. Furthermore, in some embodiments, the disclosure is also implemented as programs recorded in a recording medium. The programs include machine-readable instructions for implementing the methods according to the disclosure. Therefore, the present disclosure further covers the recording medium storing the programs for performing the methods according to the disclosure.

The descriptions of the disclosure are provided for the purpose of examples and description, and are not intended to be exhaustive or limit the disclosure to the disclosed form. Many modifications and changes are obvious to a person of ordinary skill in the art. The implementations are selected and described to better describe a principle and an actual application of the disclosure, and to make a person of ordinary skill in the art understand the embodiments of the disclosure, so as to design various implementations with various modifications applicable to particular use.

1. A method for updating a database, comprising:
searching for at least two reference image templates matching an image of a target object from among a plurality of reference image templates comprised in a first database;
performing filtering processing on the at least two reference image templates to obtain a filtered result, wherein the filtered result comprises at least one reference image template of the at least two reference image templates; and
performing merging processing on the at least one reference image template comprised in the filtered result to obtain a merged image template.

2. The method of claim 1, wherein performing the filtering processing on the at least two reference image templates to obtain the filtered result comprises:
determining a first reference image template from among the at least two reference image templates that has a greatest similarity with the image of the target object; and
performing the filtering processing on the at least two reference image templates based on the first reference image template to obtain the filtered result.

3. The method of claim 2, wherein performing the filtering processing on the at least two reference image templates based on the first reference image template to obtain the filtered result comprises:
adding one or more of at least one second reference image template, which have a similarity with the first reference image template reaching a third similarity threshold, into the filtered result, wherein the at least one second reference image template is one or more of the at least two reference image templates other than the first reference image template.

4. The method of claim 2, wherein performing the filtering processing on the at least two reference image templates based on the first reference image template to obtain the filtered result comprises:
obtaining a first updated reference feature based on the first reference image template and an image feature of the image of the target object; and
performing the filtering processing on at least one second reference image template based on similarities between reference features comprised in the at least one second reference image template and the first updated reference feature to obtain the filtered result, wherein the at least one second reference image template is one or more of the at least two reference image templates other than the first reference image template.

5. The method of claim 4, wherein performing the filtering processing on the at least one second reference image template based on the similarities between the reference features comprised in the at least one second reference image template and the first updated reference feature to obtain the filtered result comprises:
adding one or more of the at least one second reference image templates, whose reference features have respective similarities with the first updated reference feature satisfying a first condition, into the filtered result,
wherein the first condition comprises: the similarities with the first updated reference feature are greater than or equal to a third similarity threshold.

6. The method of claim 4, wherein obtaining the first updated reference feature based on the first reference image template and the image feature of the image of the target object comprises:
obtaining at least two pieces of first feature data corresponding to the first reference image template, wherein the reference feature comprised in the first reference image template is obtained based on the at least two pieces of first feature data; and
determining the first updated reference feature based on the image feature of the image and the at least two pieces of first feature data.

7. The method of claim 6, wherein determining the first updated reference feature based on the image feature of the image and the at least two pieces of first feature data comprises:
selecting at least two first updated features from among the image feature of the image and the at least two pieces of first feature data; and
obtaining the first updated reference feature based on the at least two first updated features.

8. The method of claim 7, wherein selecting the at least two first updated features from among the image feature of the image and the at least two pieces of first feature data comprises:
performing averaging processing on the image feature and the at least two pieces of first feature data to obtain a first average feature; and
selecting, based on a distance between the image feature and the first average feature as well as a distance between each of the at least two pieces of first feature data and the first average feature, the at least two first updated features from among the image feature and the at least two pieces of first feature data.

9. The method of claim 1, wherein performing the merging processing on the at least one reference image template comprised in the filtered result to obtain the merged image template comprises:
obtaining at least two pieces of second feature data corresponding to each of the at least one reference image template comprised in the filtered result, wherein a reference feature comprised in each reference image template is obtained based on the at least two pieces of second feature data corresponding to the each reference image template; and
obtaining a second updated reference feature based on the at least two pieces of second feature data corresponding to each of the at least one reference image template, wherein the merged image template comprises the second updated reference feature.

10. The method of claim 9, wherein obtaining the second updated reference feature based on the at least two pieces of second feature data corresponding to each of the at least one reference image template comprises:
selecting the at least two second updated features from among a plurality pieces of second feature data corresponding to the at least one reference image template; and
obtaining the second updated reference feature based on the at least two second updated features.

11. The method of claim 1, further comprising:
replacing the at least one reference image template stored in the first database with the merged image template.

12. The method of claim 1, wherein before performing the filtering processing on the at least two reference image templates to obtain the filtered result, the method further comprises:
determining whether similarities between the at least two reference image templates and the image satisfy a filtering condition, wherein the filtering condition comprises: a maximum of the similarities between the at least two reference image templates and the image is greater than or equal to a second similarity threshold; and
wherein performing the filtering processing on the at least two reference image templates to obtain the filtered result comprises:
in response to that the similarities between the at least two reference image templates and the image satisfy the filtering condition, performing the filtering processing on the at least two reference image templates to obtain the filtered result.

13. The method of claim 12, further comprising: in response to that the similarities between the at least two reference image templates and the image do not satisfy the filtering condition, adding a reference image template corresponding to the image into the first database.

14. A device for updating a database, comprising:
a memory storing processor-executable instructions; and
a processor arranged to execute the stored processor-executable instructions to perform operations of:
searching for at least two reference image templates matching an image of a target object from among a plurality of reference image templates comprised in a first database;
performing filtering processing on the at least two reference image templates to obtain a filtered result, wherein the filtered result comprises at least one reference image template of the at least two reference image templates; and
performing merging processing on the at least one reference image template comprised in the filtered result to obtain a merged image template.

15. The device of claim 14, wherein performing the filtering processing on the at least two reference image templates to obtain the filtered result comprises:
determining a first reference image template from among the at least two reference image templates that has a greatest similarity with the image of the target object; and
performing the filtering processing on the at least two reference image templates based on the first reference image template to obtain the filtered result.

16. The device of claim 15, wherein performing the filtering processing on the at least two reference image templates based on the first reference image template to obtain the filtered result comprises:
adding one or more of at least one second reference image template, which have a similarity with the first reference image template reaching a third similarity threshold, into the filtered result, wherein the at least one second reference image template is one or more of the at least two reference image templates other than the first reference image template.

17. The device of claim 15, wherein performing the filtering processing on the at least two reference image templates based on the first reference image template to obtain the filtered result comprises: obtaining a first updated reference feature based on the first reference image template and an image feature of the image of the target object; and
performing the filtering processing on at least one second reference image template based on similarities between reference features comprised in the at least one second reference image template and the first updated reference feature to obtain the filtered result, wherein the at least one second reference image template is one or more of the at least two reference image templates other than the first reference image template.

18. The device of claim 17, wherein performing the filtering processing on the at least one second reference image template based on the similarities between the reference features comprised in the at least one second reference image template and the first updated reference feature to obtain the filtered result comprises:
adding one or more of the at least one second reference image templates whose reference features have respective similarities with the first updated reference feature satisfying a first condition, into the filtered result,
wherein the first condition comprises: the similarities with the first updated reference feature are greater than or equal to a third similarity threshold.

19. The device of claim 17, wherein obtaining the first updated reference feature based on the first reference image template and the image feature of the image of the target object comprises:
obtaining at least two pieces of first feature data corresponding to the first reference image template, wherein the reference feature comprised in the first reference image template is obtained based on the at least two pieces of first feature data; and
determining the first updated reference feature based on the image feature of the image and the at least two pieces of first feature data.

20. A non-transitory computer-readable storage medium having stored thereon computer-readable instructions that, when executed by a processor, cause the processor to perform a method of updating a database, the method comprising:
searching for at least two reference image templates matching an image of a target object from among a plurality of reference image templates comprised in a first database;
performing filtering processing on the at least two reference image templates to obtain a filtered result, wherein the filtered result comprises at least one reference image template of the at least two reference image templates; and
performing merging processing on the at least one reference image template comprised in the filtered result to obtain a merged image template.
